(19) United States
(12) Patent Application Publication
(10) Pub. No.: US 2026/0097807 A1
(43) Pub. Date: Apr. 9, 2026

(54) Systems and Methods for Steering Control for a Hydraulic Machine

(71) Applicant: HUSCO International, Inc., Waukesha, WI (US)

(72) Inventor: Kyle Hrodey, Waukesha, WI (US)

(21) Appl. No.: 19/114,231

(22) PCT Filed: Sep. 25, 2023
(86) PCT No.: PCT/US2023/075035

§ 371 Date: Mar. 21, 2025

Related U.S. Application Data
(60) Provisional application No. 63/409,614, filed on Sep. 23, 2022.

(51) Int. Cl. B62D 5/07; B62D 5/09

(52) U.S. Cl. CPC B62D 5/07; B62D 5/09

(57) ABSTRACT

A control valve for a steering system for a hydraulic machine includes a valve body defining a first actuator port, a second actuator port, a tank port, a pump port, and a manual steer interface. A directional control spool is disposed within the valve body to selectively couple the first actuator port, the second actuator port, the tank port, and the pump port. Additionally, an isolator spool is disposed within the valve body to selectively couple the directional control spool to each of the first actuator port, the second actuator port, and the pump port, and to selectively couple the pump port to the manual steer interface.

### CROSS-REFERENCE TO RELATED APPLICATIONS

This application claims the benefit of U.S. Provisional Patent Application Ser. No. 63/409,614, filed on Sep. 23, 2022, which is incorporated herein by reference in its entirety.

### BACKGROUND

Steering systems can be used to control a direction of travel of a hydraulic machine. A steering system can include a steering control valve configured control a flow of hydraulic fluid an actuator to adjust a steering direction. Such steering control valves can include manual steering valves configured to control a steering direction based on an operator input, and electronic steering valves configured to control a steering direction based on an electronic signal, such as for remote, autonomous, or other electronic control of the hydraulic machine.

### BRIEF SUMMARY

A steering system, as described herein, can allow for both manual and electronic control of a hydraulic machine. In general, a steering system can include an electronic steering valve (e.g., a first valve section) that is configured to couple to a manual steering valve (e.g., a second valve section). The electrohydraulic steering valve can include an isolator spool that can switch the steering system between a manual steering mode and an electronic steering mode.

According to one aspect of the disclosure, a control valve for a steering system for a hydraulic machine can include a valve body defining a first actuator port, a second actuator port, a tank port, a pump port, and a manual steer interface. A directional control spool can be disposed within the valve body to selectively couple the first actuator port, the second actuator port, the tank port, and the pump port. Further, an isolator spool can be disposed within the valve body to selectively couple the directional control spool to each of the first actuator port, the second actuator port, and the pump port, and to selectively couple the pump port to the manual steer interface.

In some non-limiting examples, the directional control spool can be configured to move between each of a first directional position, a second directional position, and a third directional position. In the first directional position, the directional control spool can be configured to couple each of the first actuator port and the second actuator port to the tank port. In the second directional position, the directional control spool can be configured to couple the pump port to the first actuator port and to couple the second actuator port to the tank port. In the third directional position, the directional control spool can be configured to couple the pump port to the second actuator port and to couple the first actuator port to the tank port. In some cases, the control valve can include a biasing assembly configured to bias the directional control spool into the first directional position. The biasing assembly can include a first directional control spring and a second directional control spring, which can be in an opposed configuration about the directional control spool to bias the directional control spool into the first directional position.

In some non-limiting examples, the control valve can further include a first electronically controlled pressure regulating valve and a second electronically controlled pressure regulating valve. The first electronically controlled pressure regulating valve can be configured to move the directional control spool from the first directional position to the second directional position. The second electronically controlled pressure regulating valve can be configured to move the directional control spool from the first directional position to the third directional position. In some cases, each of the first electronically controlled pressure regulating valve and the second electronically controlled pressure regulating valve can be movable between a first position that couples a respective pilot pressure connection of the directional control spool to the tank port and a second position that couples the respective pilot pressure connection to the pump port.

In some non-limiting examples, the isolator spool can be configured to move between each of a first isolator position, a second isolator position, and a third isolator position. In the first isolator position, the isolator spool can be configured to block the first actuator port and the second actuator port from the directional control spool, and to couple the pump port to the manual steer interface. In the second isolator position, the isolator spool can be configured to block the manual steer interface from the pump port and to couple the directional control spool to each of the first actuator port, the second actuator port, and the pump port. In the third isolator position, the isolator spool can be configured to couple the pump port to the manual steer interface and to couple the directional control spool to each of the first actuator port, the second actuator port, and the pump port. In some cases, the control valve can further include a first isolator spring configured to bias the isolator spool to the first isolator position. In some cases, the control valve can further include a second isolator spring arranged in series with the first isolator spring to bias the isolator spool to the first isolator position.

In some non-limiting examples, a pressure connection of the isolator spool can be coupled to the pump port, and the control valve can further include an enable solenoid to selectively couple the pressure connection to the tank port to control movement of the isolator spool. In some cases, the pressure connection can be a first pressure connection and the control valve can further include a second pressure connection arranged opposite isolator spool from the first pressure connection. A restriction orifice can be positioned between the pump port and the pressure connection. The enable solenoid can be configured as one of an on-off solenoid and proportional solenoid. The enable solenoid can be operable between each of a disable position and an enable position. In the disable position, the enable solenoid can be configured to couple the pressure connection to the tank port so that the isolator spool is biased to the first isolator position. In the enable position, the enable solenoid can be configured to block the pressure connection from the tank port so that pressure at the pump port moves the isolator spool from the first isolator position toward the second isolator position. In some cases, with the enable solenoid in the enable position, position of the isolator spool can be infinitely variable between the second isolator position and the third isolator position based on a pressure at the pressure connection.

In some non-limiting examples, the manual steer interface can be configured to couple with a manual steer valve and can include a pump connection, a tank connection, a first actuator connection, and a second actuator connection.

According to another aspect of the disclosure, a steering system is provided for a hydraulic machine having a pump, an actuator, and a tank. The steering system can include a manual steering valve including a first pump connection, a first tank connection, a first actuator connection, and a second actuator connection. The manual steering valve can be configured to selectively couple the first pump connection, the first tank connection, the first actuator connection, and the second actuator connection. The steering system can further include an electronic steering valve. The electronic steering valve can include a valve body defining a pump port configured to couple to the pump, a first actuator port configured to couple to the actuator, a second actuator port configured to couple to the actuator, a tank port configured to couple to the tank, a second pump connection configured to couple to the first pump connection, a second tank connection configured to couple to the first tank connection, a third actuator connection configured to couple to the first actuator connection, and a fourth actuator connection configured to couple to the second actuator connection. A directional control spool can be disposed within the valve body. The directional control spool can be configured to selectively couple the pump port, the first actuator port, the second actuator port, and the tank port. Further, an isolator spool can be disposed within the valve body. The isolator spool can be configured to switch the steering system between a manual steering mode and an electronic steering mode. In the manual steering mode, the directional control spool can be decoupled from the pump port, the first actuator port, and the second actuator port by the isolator spool. In the electronic steering mode, the directional control spool can be coupled to the pump port, the first actuator port, and the second actuator port by the isolator spool.

In some non-limiting examples, the third actuator connection can be in direct communication with the first actuator port, and the fourth actuator connection can be in direct communication with the second actuator port. In the manual steering mode, the isolator spool can be in a first isolator position that blocks the first actuator port and the second actuator port from the directional control spool, and couples the pump port to the manual steering valve. In the electronic steering mode, the isolator spool can be movable between each of a second isolator position and a third isolator position. In the second isolator position, the isolator spool can be configured to block the manual steer valve from the pump port and to couple the directional control spool to each of the first actuator port, the second actuator port, and the pump port. In the third isolator position, the isolator spool can be configured to couple the pump port to the manual steer valve and to couple the directional control spool to each of the first actuator port, the second actuator port, and the pump port.

In some non-limiting examples, the steering system can further include an electronic controller configured to move the isolator spool to switch between the manual steering mode and the electronic steering mode. The electronic controller can be configured to operate an enable solenoid. The enable solenoid can be configured to selectively couple a pressure connection of the isolator spool to the tank port to put the steering system in the manual steering mode, and to decouple the pressure connection to the tank port to put the steering system in the electronic steering mode. In the electronic steering mode, the electronic controller can be configured operate a first electronically controlled pressure regulating valve and a second electronically controlled pressure regulating valve to move the directional control spool between each of a first directional position, a second directional position, and a third directional position. In the first directional position, the directional control spool can be configured to couple each of the first actuator port and the second actuator port to the tank port. In the second directional position, the directional control spool can be configured to couple the pump port to the first actuator port and to couple the second actuator port to the tank port. In the third directional position, the directional control spool can be configured to couple the pump port to the second actuator port and to couple the first actuator port to the tank port.

In some non-limiting examples, the actuator can include a first actuator and a second actuator. The first actuator can be coupled to the first actuator port and the second actuator can be coupled to the second actuator port.

The disclosure will be better understood, and features, aspects, and advantages will become apparent when consideration is given to the following detailed description thereof. Such detailed description references to the following drawings.

### BRIEF DESCRIPTION OF THE DRAWINGS

FIG. 1 is a schematic view of a steering system, according to aspects of the disclosure.

FIG. 2 is a detail schematic view of a non-limiting example of an electronic steering valve of the steering system FIG. 1.

FIG. 3 is a partial cross-sectional view of the electronic steering valve of FIG. 2, with an isolator spool in a first position.

FIG. 4 is a partial cross-sectional view of the electronic steering valve of FIG. 2, with the isolator spool in a second position.

FIG. 5 is a partial cross-sectional view of the electronic steering valve of FIG. 2, with the isolator spool in a third position.

FIG. 6 is a detail schematic view of another non-limiting example of an electronic steering valve of the steering system FIG. 1.

FIG. 7 is a partial cross-sectional view of the electronic steering valve of FIG. 6, with an isolator spool in a first position.

FIG. 8 is a partial cross-sectional view of the electronic steering valve of FIG. 6, with the isolator spool in a second position.

FIG. 9 is a partial cross-sectional view of the electronic steering valve of FIG. 6, with the isolator spool in a third position.

### DETAILED DESCRIPTION

Before any aspects of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings and may also indicate fluid couplings.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown, but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

As mentioned above, a hydraulic machine (e.g., off-highway machines such as tractors, forklifts, backhoes, wheel-loaders, excavators, etc.) can include a steering system to control a direction of travel of the hydraulic machine. Conventional hydraulic machines may be equipped with manual steering functionality and can including a traditional, manual steering valve that is configured to control an actuator in response to a manual input by an operator to adjust a steering direction of the hydraulic machine. In some cases, a hydraulic machine can also be equipped with an electronic steering valve, which may be used in conjunction with external sensors to allow for, remote, autonomous, or semi-autonomous steering capability.

Typically, where both manual and electronic steering control is provided, a steering system includes a manual steering device and an electronic steering device. To switch between manual and electronic steering modes, conventional systems typically include a separate pump isolation device that determines which steering system is active (e.g., manual, or electronic), and a separate work port blocking circuit that isolates the manual steering valve from the electronic steering valve (e.g., by isolating a directional control element of the electronic steering valve from the actuator). Where the steering system includes a fixed displacement pump to provide the requisite fluid flow, a separate unloading device may also be required to allow excess flow (e.g., flow not being consumed by an actuator) to drain to tank. The need for these separate components to allow for both manual and electric steering increase system costs and complexity, and also can increase the overall size of the system.

A steering system according to the present disclosure can provide improvements over conventional designs by integrating a pump isolation device, work port blocking circuit, and unloading device into a single logic element (e.g., a flow control element, such as a spool valve) within the electronic steering valve. For example, a steering system can include a manual steering valve coupled to a pump, a tank, and an actuator via an electronic steering valve. A flow control element can be movably disposed within a housing of the electronic steering valve to switch the steering system between a manual steering mode and an electronic steering mode (e.g., an autonomous or semi-electronic steering mode). Movement of the flow control element (i.e., the first flow control element) within the housing can selectively couple the pump, actuator, and tank with the manual steering valve and a second flow control element of the electronic steering valve that is configured to direct fluid to one or more actuators to adjust a steering angle.

In some cases, switching between a manual steering mode an electronic steering mode can be controlled through operation of an enable solenoid. The enable solenoid can move between a disable position that moves the first flow control element into a first position that allows for manual control and isolates the second flow control element from the pump and actuators, and an enable position that couples the pump and actuator to the second flow control element. When excess flow is provided, the first flow control element can be configured to drain the excess flow to tank through the manual steering valve.

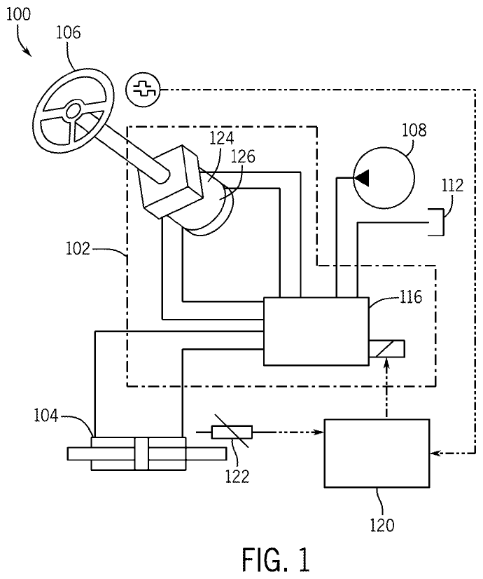

Referring to FIG. 1, a hydraulic vehicle can include a steering system 100 to provide directional control of the hydraulic vehicle. The steering system 100 includes an actuator 104 that can control a steering direction of the hydraulic vehicle. For example, the actuator 104 can be operated (e.g., extended or retracted) to control an angle of a wheel of the hydraulic machine. Depending on the particular implementation, the actuator 104 may be a single actuator (e.g., a double-acting hydraulic actuator) or multiple actuators (e.g., a first and a second single acting hydraulic actuator). Correspondingly, a pump 108 (e.g., a variable or constant displacement pump) can be provided to supply a flow of hydraulic fluid to the actuator 104, and a tank 112 can be provided to allow fluid from the actuator 104 to drain.

To control operation of the actuator 104, the steering system 100 can include a control valve 102 (e.g., a steering control valve) configured to selectively couple the actuator 104 to the pump 108 and the tank 112. The control valve 102 can be configured to allow for both manual control of the steering system 100 and electronic control (e.g., autonomous, or semi-autonomous control) of the steering system. To allow for manual control, the steering system 100 can include a manual steering valve 124 (e.g., a first control valve). In general, the manual steering valve 124 can include a valve body 126 configured to house a control element to operate the actuator 104 by directing fluid between the pump 108, the actuator 104, and the tank 112. Correspondingly, and as will be described in greater detail below, the valve body 126 can define a pump connection 128 (e.g., a first pump connection) configured to receive fluid flow from the pump 108, a tank connection 132 (e.g., a second pump connection) configured to drain fluid to the tank 112, and a first work port connection 136 (e.g., a first actuator connection) and a second work port connection 144 (e.g., a second actuator connection) configured to allow fluid flow between the actuator 104 and the manual steering valve 124.

The manual steering valve 124 can be any type of conventional steering valve, for example, an orbitrol valve or directional control valve. The manual steering valve 124 can be configured to operate the actuator 104 in a manual steering mode in response to an operator input. In some cases, the manual steering valve 124 can be physically coupled with a manual input device 106 (e.g., a steering wheel, joystick, foot-pedals, etc.), at which the operator provides a steering input. Relatedly, the manual input device 106 can be installed on the hydraulic machine. In addition, the manual control interface can be configured to allow an operator to switch from the manual steering mode to the electronic steering mode, and vice versa (e.g., via a button or switch).

To allow for electronic control, the steering system 100 can further include an electronic steering valve 116 (e.g., a second control valve). The electronic steering valve 116 can be a single control valve (e.g., a single valve block or valve section) that can be installed on a hydraulic machine, as compared with conventional designs where multiple valve blocks are provided to control, for example; electronic control activation and electronic control steering. As will become apparent in the discussion below, providing the electronic steering valve 116, as a single valve block can achieve numerous benefits over conventional systems, including, for example, increased operating efficiency and reducing the need for separate controllers and external conduits to connect and operate the electronic steering valve 116 with the various machine functions. The use of a single valve block may further reduce space occupied by the electronic steering valve 116, allowing for improved packaging.

The electronic steering valve 116 can be coupled to a controller 120. As discussed further below, the electronic steering valve 116 may receive commands from the controller 120 to operate the actuator 104 in an electronic steering mode, as well as to switch the steering system 100 between the electronic steering mode and the manual steering mode. In some case, the controller 120 can receive input from a sensor 122 (e.g., a wheel angle sensor) corresponding to a steering angle of the steering system 100. The controller 120 can control the electronic steering valve 116, and thus the actuator 104, based on the signal from the sensor 122 to move the steering system 100 between a current steering angle and a desired steering angle. Additionally, the controller 120 can be in communication with the manual input device 106. As such, the operator can control the steering mode of the steering system 100 as mentioned above. Alternatively, the controller 120 may be configured to switch automatically between steering modes. For example, the controller 120 can be configured to automatically switch to the manual steering mode upon receiving a manual input while in the electronic steering mode. As another example, upon reaching a particular work area or completion of a work task, the controller 120 may be configured to automatically switch from a manual steering mode to the electronic steering mode.

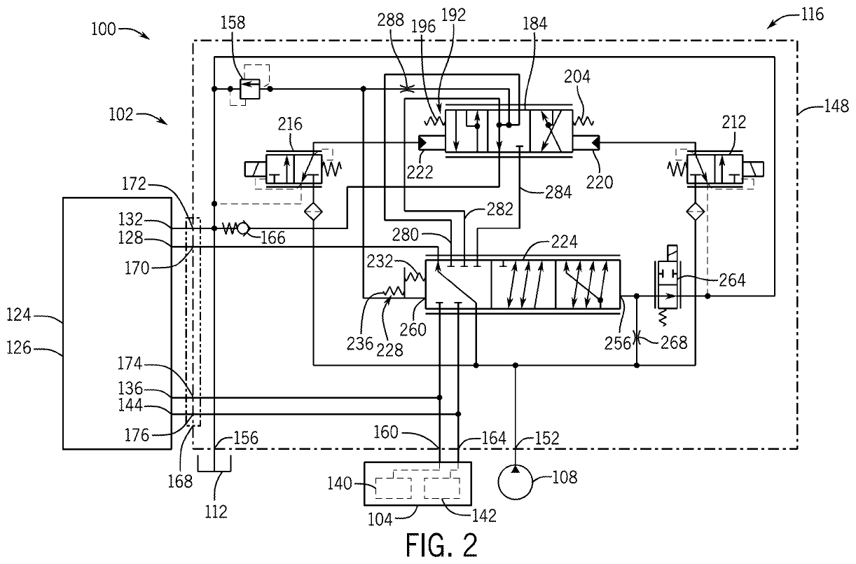

With additional reference to FIG. 2, the electronic steering valve 116 can be positioned between the manual steering valve 124 and each of the pump 108, the actuator 104, and the tank 112. In this way, the drive mode of the steering system 100 can be set by the controlling the electronic steering valve 116. It is appreciated that the electronic steering valve 116 can be directly or indirectly coupled (e.g., via a conduit) to the manual steering valve 124. For example, the electronic steering valve 116 and the manual steering valve 124 can be configured as valve sections that couple together to form a main valve. In other cases, they can be separate valves configured for direct or indirect coupling to one another, such as for use as a retrofit kit application. Accordingly, the manual steering valve 124 and the electronic steering valve 116 may be installed in the same or different locations on the hydraulic machine.

The electronic steering valve 116 can include a valve body 148 that defines a pump port 152 configured to couple to the pump 108, a tank port 156 configured to couple to the tank 112, a first work port 160 (e.g., a first actuator port), and a second work port 164 (e.g., a second actuator port). Fluid may flow between the actuator 104 and each of the first work port 160 or the second work port 164 to steer the hydraulic vehicle (e.g., either right or left). It is appreciated that the valve body 148 can define various internal passages to allow the fluid to flow between the various ports, connections, and components, as described herein.

In the illustrated non-limiting example, the actuator 104 is configured as an actuator system that include a first actuator 140 and a second actuator 142 (collectively, the actuator 104). The first work port 160 is configured to couple to the first actuator 140 and the second work port 164 is configured to couple the second actuator 142. To steer in a first direction, fluid can flow from the pump 108 to the to the first actuator 140 via the first work port 160, and from the second actuator 142 to the tank 112 via the second work port 164. To steer in a second, opposite direction, fluid can flow from the pump 108 to the to the second actuator 142 via the second work port 164, and from the first actuator 140 to the tank 112 via the first work port 160. In other non-limiting examples, in particular those with a single, double-acting actuator, the work ports can be coupled to opposing sides of the actuator.

To couple to the manual steering valve 124, the valve body 148 can further define a manual steering interface 168 configured to couple to the manual steering valve 124. The manual steering interface 168 can include a pump connection 170 (e.g., a second pump connection) configured to couple to the pump connection 128 of the manual steering valve 124, a tank connection 172 (e.g., a second tank connection) configured to couple to the tank connection 132 of the manual steering valve 124, a first work port connection 174 (e.g., a third work port or actuator connection) configured to couple to the first work port connection 136 of the manual steering valve 124, and a second work port connection 176 (e.g., a fourth work port or actuator connection) configured to couple to the second work port connection 144 of the manual steering valve 124. The tank connection 172 can be coupled to the tank port 156, the first work port connection 174 can be coupled to the first work port 160, and the second work port connection 176 can be coupled to the second work port 164 to allow direct fluid communication therebetween.

However, as will be described in greater detail below, a control element can be provided between the pump port 152 and the pump connection 170 to selectively isolate the pump 108 flow to the manual steering valve 124 to control a steering mode. That is, rather that providing flow to another control element of electronic steering valve 116, the pump flow will be isolated to flow to the manual steering valve 124 to be used in accordance with an operator input. For example, the control element can couple the pump port 152 and the pump connection 170 in the manual steering mode, such that pump 108 flow is distributed to the actuator 104 (e.g., the first actuator 140 and the second actuator 142) by the manual steering valve 124 in accordance with an operator input. However, in the electronic steering mode, the control element may selectively isolate the pump port 152 from the pump connection 170 to allow the electronic steering valve 116, via commands from the controller 120, to control the actuator 104.

To control steering in the electronic steering mode, the electronic steering valve 116 can be configured to selectively couple the actuator 104 (e.g., the first actuator 140 and the second actuator 142) to the pump 108 and the tank 112. More specifically, the electronic steering valve 116 can include a flow control element configured to selectively couple the pump port 152, the tank port 156, the first work port 160 and the second work port 164. In the illustrated non-limiting example, the electronic steering valve 116 includes a directional control spool 184 that can be movably disposed within the valve body 148 to move between a plurality of positions (e.g., directional positions) to control fluid flow to the actuator 104, and thus a steering direction of the steering system 100. Movement of the directional control spool 184 can allow fluid flow into, out of, or between the one or more passages formed within the valve body 148 to achieve the desired steering direction. In the illustrated non-limiting example, the directional control spool 184 is configured to move between three directional positions. The directional control spool 184 can be configured to move discretely or infinitely variably between the positions.

The first directional position may be used when no steering input is necessary, for example when the hydraulic machine is traversing substantially straight, or when the electronic steering is deactivated. The first directional position can be configured to couple each of the first work port 160 and the second work port 164 to the tank port 156, and to block the first work port 160 and the second work port 164 from pump port 152. Accordingly, when the directional control spool 184 is coupled to the first work port 160 and the second work port 164, the first actuator 140 and the second actuator 142 can drain to tank 112, provided these connections are not otherwise blocked, as described below. In some cases, a spring biased check valve 166 can be positioned between the tank port 156 and the directional control spool 184 to maintain the actuator 104 at a predetermined minimum pressure, or to prevent fluid from flowing from the tank 112 back to the actuator 104.

The second directional position and the third directional position can be used to selectively operate the first actuator 140 and the second actuator 142 to change a steering direction. In particular, the second directional position can be configured to couple the first work port 160 to the pump port 152 to supply fluid to the first actuator 140 (e.g., to extend the first actuator 140), and to couple the second work port 164 to the tank port 156 to drain fluid from the second actuator 142 to tank 112 (e.g., to retract the second actuator 142). Thus, the second directional position can cause the steering system 100 to steer in a first direction. Conversely, the third directional position can be configured to couple the second work port 164 to the pump port 152 to supply fluid to the second actuator 142 (e.g., to extend the second actuator 142), and to couple the first work port 160 to the tank port 156 to drain fluid from the first actuator 140 to tank 112 (e.g., to retract the first actuator 140). Accordingly, the third directional position can cause the steering system 100 to steer in a second direction that is opposite the first direction.

In some cases, to prevent over-pressurization of the first actuator 140 and the second actuator 142 in the second directional position and the third directional position, a relief valve 158 can be provided between the directional control spool 184 and the tank port 156. The first actuator 140 and the second actuator 142 can be coupled with the relief valve 158 via the directional control spool 184. In some cases, a restriction orifice 288 can be positioned between the relief valve 158 and the directional control spool 184. The restriction orifice 288 can limit the flow out the relief valve 158 in the event pressure in the active work port exceeds the setpoint of the relief valve 158.

To provide electronic steering, the directional control spool 184 can be configured to be moved between the directional control positions by the controller 120. For example, referring still referring to FIG. 2, the directional control spool 184 can be configured as a spring biased directional control spool that includes a biasing assembly 192 to bias the directional control spool 184 into the first directional position. The biasing assembly 192 includes a first compliant member 196 (e.g., a first directional control spring or other type resilient member) arranged on a first side of the directional control spool 184 and a second compliant member 204 (e.g., a second control spring or other type of resilient member) arranged on a second side of the directional control spool 184. Accordingly, a first compliant member 196 and the second compliant member 204 are in an opposed configuration about the directional control spool 184. The first compliant member 196 and the second compliant member 204 can be set with an initial preload compression so the directional control spool 184 is biased to the first directional position. In some examples, the first compliant member 196 and the second compliant member 204 can be set with a substantially similar preload compression. In some examples, a single spring can be used and arranged to bias the directional control spool 184 to the first directional control position.

To move the directional control spool 184 from the first directional position toward each of the second and third directional positions, electronic steering valve 116 can include one or more electronically controlled pressure regulating valves (EPRVs), or another type of electrohydraulic control element (e.g., a solenoid). In the illustrated non-limiting example, the electronic steering valve 116 includes a first EPRV 212 and a second EPRV 216. The first EPRV is coupled between the pump port 152 and a first pilot pressure connection 220 of the directional control spool 184, which is provided on the second side of the directional control spool 184, opposite the first compliant member 196. Correspondingly, second EPRV 216 is coupled between the pump port 152 and a second pilot pressure connection 222 of the directional control spool 184, which is provided on the first side of the directional control spool 184, opposite the second compliant member 204.

Each of the first EPRV 212 and the second EPRV 216 can be operated (e.g., energized) by the controller 120 to move from a first position (e.g., a first steer position) configured to couple the respective pilot pressure connection to tank 112 (e.g., the tank port 156) to relieve pressure, and a second position (e.g., a second steer position) configured to couple the respective pilot pressure connection to the pump 108 (e.g., the pump port 152) to increase pressure. The first EPRV 212 and the second EPRV 216 are biased to the first position. Accordingly, with the first EPRV 212 and the second EPRV 216 deactivated, both the first pilot pressure connection 220 and the second pilot pressure connection 222 are connected to tank 112 and the directional control spool 184 is biased by the compliant members 196, 204 to the first directional position. Activating the first EPRV 212 will increase pressure at the first pilot pressure connection 220, causing the first compliant member 196 to compress, and moving the directional control spool 184 to the second directional position. Activating, the second EPRV 216 will increase pressure at the second pilot pressure connection 222, causing the second compliant member 204 to compress, and moving the directional control spool 184 to the third directional position. It is appreciated that only one EPRV may be activated at a time.

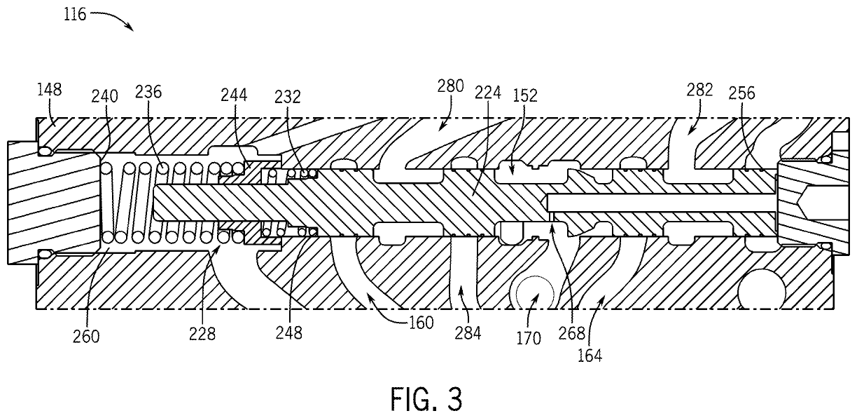

With additional reference to FIGS. 3-5, to control a steering mode of the steering system 100, the electronic steering valve 116 can further include an isolator spool 224 (e.g., a flow control element). The isolator spool 224 can be moveably disposed within the valve body 148 to switch between the manual steering mode and the electronic steering mode (i.e., to activate and deactivate electronic steering). More specifically, the isolator spool 224 is configured to move to selectively couple the directional control spool 184 to each of the first work port 160, the second work port 164, and the pump port 152, and to selectively couple the pump port 152 to the manual steering interface 168 (e.g., at the pump connection 170). Accordingly, the isolator spool 224 can selectively activate and deactivate the electronic steering mode of the hydraulic vehicle. To activate the electronic steering mode, the isolator spool 224 can couple the directional control spool 184 to each of the first work port 160, the second work port 164, and the pump port 152. To deactivate the electronic steering mode (i.e., to activate a manual steering mode), the isolator spool 224 can couple the pump port 152 to the manual steering interface 168 and decouple the directional control spool 184 from each of the first work port 160, the second work port 164, and the pump port 152. The coupling of the pump port 152 to the manual steering interface 168 can allow fluid to bypass the directional control spool 184 to flow into and operate the manual steering valve 124. Put differently, in the manual steering mode, the isolator spool 224 can be configured isolate the directional control spool 184 from the manual steering valve 124 to ensure that the operator maintains control over the steering system 100, even if the directional control spool 184 were to move toward either of the second or third directional positions.

To switch between steering modes, the isolator spool 224 may be movable between a plurality of positions (i.e., isolator positions). Movement of the isolator spool 224 between the various positions can control fluid flow into, out of, or between the one or more passages formed within the valve body 148 to couple and decouple the various ports as described above. In the illustrated non-limiting example, the isolator spool 224 is configured to move between three isolator positions.

In the first isolator position (see e.g., FIG. 3), the isolator spool 224 is configured to place the steering system 100 in the manual steering mode by isolating the directional control spool 184 from the manual steering valve 124 and the actuator 104 (e.g., the first actuator 140 and the second actuator 142). More specifically, in the first isolator position, the isolator spool 224 is configured to block connections (e.g., passages) between the isolator spool 224 and each of the first work port 160 and the second work port 164, as well as corresponding passages 280, 282 (e.g., first and second passages) that allow fluid flow to and from the actuator 104 to pass between the directional control spool 184 and the isolator spool 224. Thus, the isolator spool 224 blocks and isolates each of the first work port 160 and the second work port 164 from the directional control spool 184. Additionally, the isolator spool 224 is configured to block a third passage 284 that allows fluid from the pump 108 to pass from the isolator spool 224 to the directional control spool 184, where it can then be distributed to the actuator 104 via passages 280, 282. Moreover, in the first isolator position, the isolator spool 224 is further configured to couple the pump port 152 to the pump connection 170 to allow flow from the pump 108 to be supplied to the manual steering valve 124. Accordingly, the manual steering valve 124 can then direct flow from the pump 108 to the actuator 104 by selective coupling the pump connection 170, tank connection 172, first work port connection 174, and the second work port connection 176 in accordance with an operator input at the manual input device 106.

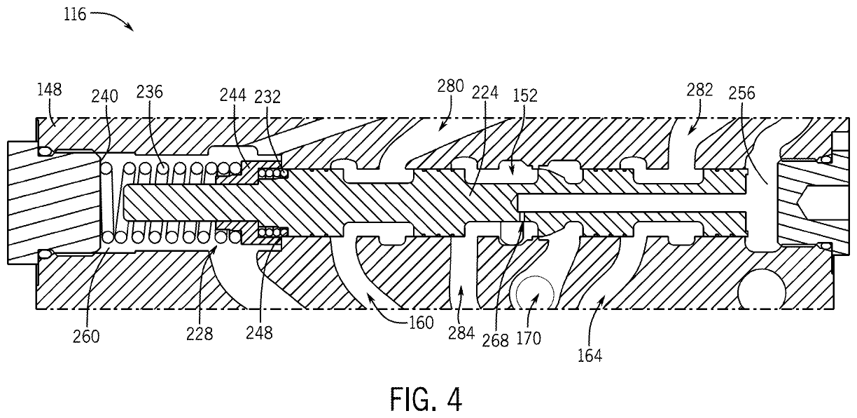

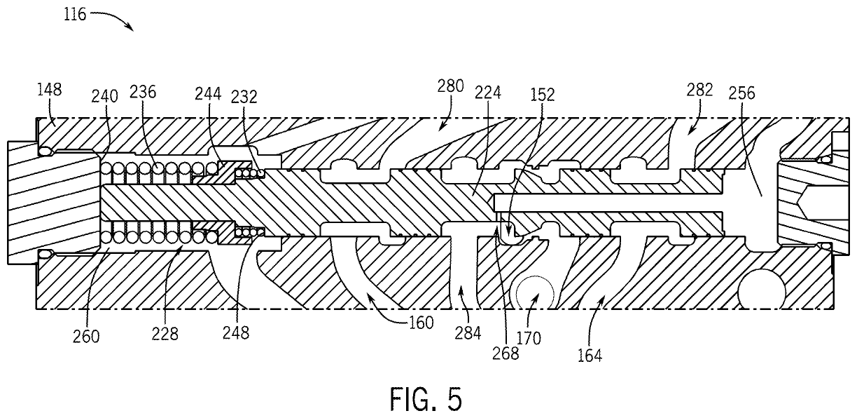

In the second isolator position (see e.g., FIG. 4) and the third isolator position (see e.g., FIG. 5), the isolator spool 224 is configured to place the steering system 100 in the electronic steering mode by coupling the directional control spool 184 with the pump 108, the actuator 104, and the tank 112. More specifically, in both the second isolator position and the third isolator position, the isolator spool 224 couples the first work port 160 to the directional control spool 184 via the first passage 280, couples the second work port 164 to the directional control spool 184 via second passage 282, and couples the pump port 152 to the directional control spool 184 via the third passage 284. As such, the pump 108 can supply fluid operate the actuator 104 in accordance with the position of the directional control spool 184, as described above. Correspondingly, fluid flow from the actuator 104 (e.g., from retraction of either the first actuator 140 or the second actuator 142) can drain to the tank 112 via the directional control spool 184 (e.g., through the spring biased check valve 166).

However, in the second isolator position, the isolator spool 224 is configured to block the pump port 152 from the pump connection 170 (e.g., the manual steering valve 124), while in the third isolator position, the isolator spool 224 is configured to couple the pump port 152 to the pump connection 170 (e.g., the manual steering valve 124). Consequently, the second isolator position can be a blocking position that allows all pump flow to be supplied to the actuator 104 and the third isolator position can be an unloading position that allows excess pump flow to be drained to the tank 112 via the manual steering valve 124. That is, in the third isolator position, manual steering valve 124 can be in a neutral or bypass mode that is configured to allow flow supplied at the pump connection 170 to drain directly to the tank 112 through the tank connection 172. For example, a control element of the manual steering valve 124 can couple the pump connection 128 to the tank connection 132, while blocking the first work port connection 136 and the second work port connection 144. As explained in greater detail below, the isolator spool 224 can be positioned infinitely variably between the second isolator position and the third isolator position in accordance with a demand of the actuator 104 (e.g., a position of the directional control spool 184).

Still referring to FIGS. 2-5, the isolator spool 224 can be biased to the first isolator position and be moved to the second or third isolator positions in accordance with a command from the controller 120. Accordingly, the isolator spool 224 can include a biasing assembly 228 (e.g., an isolator biasing assembly) configured to bias the isolator spool 224 into the first isolator position. More specifically, the biasing assembly 228 may include one or more compliant members. In the illustrated non-limiting example, the biasing assembly 228 is positioned at a first end of the isolator spool 224 and includes a first compliant member 232 (e.g., a first isolator spring or other type resilient member) and a second compliant member 236 (e.g., a second isolator spring or other type of resilient member) that are arranged in series with one another. The first compliant member 232 and/or the second compliant member 236 can be set with an initial preload compression so as to bias the isolator spool 224 to the first isolator position. The second compliant member 236 extends and is retained between a first seat 240 and a second seat 244. The first seat 240 can be a fixed seat, in this case formed by the valve body 148 (e.g., a cap secured to the valve body 148). The second seat 244 can be configured as a floating seat that is movably disposed within the valve body 148. The first compliant member 232 extends and is retained between the second seat 244 and a third seat 248, which is defined by the isolator spool 224. In other non-limiting examples, the first and second compliant members can be arranged differently. For example, the first compliant member 232 can extend and be retained between a first seat 240 and a second seat 244, and the second compliant member 236 can extend and be retained between the second seat 244 and a third seat 248.

The first compliant member 232 and the second compliant member 236 can be compressed between the first seat 240 and the third seat 248 to allow the isolator spool 224 to move from the first isolator position, through the second isolator position, to the third isolator position. In some configurations, the first compliant member 232 may be configured to fully compress before the second compliant member 236 begins to compress. For example, in some configurations, the second compliant member 236 may have sufficient initial precompression (e.g., an initial preload) such that the first compliant member 232 will compress first. In this way, the first compliant member 232 can be selectively compressed to move the isolator spool 224 between the first isolator position and the second isolator position to switch the steering system between the manual steering mode and the electronic steering mode. Correspondingly, in the electronic steering mode, the second compliant member 236 can be selectively compressed to vary the position of the isolator spool 224 anywhere between the second and third isolator positions. Put another way, the second compliant member 236 is configured to adjust to maintain margin pressure between the first and second ends of the isolator spool 224 as system pressure and flow demand changes, which varies the position of the isolator spool 224.

The position of the isolator spool 224 can be controlled using fluid pressure in the steering system 100, or by another control method (e.g., applying a force to the isolator spool 224 with a solenoid or other actuator, etc.). In the illustrated non-limiting example, the isolator spool 224 is moved using fluid pressure in the steering system 100. More specifically, the isolator spool 224 includes a pressure connection 256 (e.g., a first load sense or pilot pressure connection, or chamber) arranged on a second end of the isolator spool 224, opposite the biasing assembly 228. In this way, fluid pressure applied at the pilot pressure connection is configured to act against the force of first compliant member 232 and the second compliant member 236, thereby compressing the springs and moving the isolator spool 224.

The pressure connection 256 is connected to the pump port 152 and can be selectively coupled to the tank port 156 to control a pressure at the pressure connection 256, and thus, the position of the isolator spool 224 and the steering mode. More specifically, the pressure connection 256 can be coupled to the tank 112 (e.g., to drain to tank) to reduce pressure at the pressure connection 256, allowing the biasing assembly 228 to move the isolator spool 224 into first isolator position. In some cases, restriction orifice 268 can be provided between the pump port 152 and the pressure connection 256 to limit flow from the pump 108 to the tank 112 through the pressure connection 256. The restriction orifice 268 can also reduce the pressure at the pressure connection 256.

Conversely, blocking the pressure connection 256 from the tank 112 allows pressure at the pressure connection 256 to increase, which causes the first compliant member 232 to compress to move the isolator spool 224 to the second or third isolator position, depending on the magnitude of the pressure. With the tank 112 blocked, variations in the steering system 100 pressure (e.g., in accordance with actuator consumption) can compress the second compliant member 236 to vary the isolator spool 224 between the second and third isolator positions. For example, movement of the directional control spool 184 to each of the second and third directional positions will increase fluid consumption of the actuator 104, reducing pressure at the pressure connection 256. This results in a force imbalance at the isolator spool 224, such that the second compliant member 236 will extend and automatically move the isolator spool 224 toward the second isolator position to provide the required flow. Correspondingly, movement of the directional control spool 184 to the first directional position will reduce actuator 104 consumption, causing pressure at the pressure connection 256 to build, which compresses the second compliant member 236 and automatically moves the isolator spool 224 toward the third isolator position to drain excess flow to tank 112 via the manual steering valve 124.

Thus, by selectively connecting the pressure connection 256 to tank 112, the steering system 100 can switch between the manual steering mode and the automatic steering mode. As such, only a single connection needs to be controlled to change the steering mode. As shown in the illustrated non-limiting example, an enable solenoid 264 (e.g., a proportional or on/off solenoid, or another type of actuator, such as an EPRV) can be positioned between the pressure connection 256 and the tank port 156 to selectively couple the pressure connection 256 to the tank 112.

The enable solenoid 264 can be in communication with the controller 120. The controller 120 can command the enable solenoid 264 to move between a first position (e.g., a disable position) that couples the pressure connection 256 to the tank 112, and a second position (e.g., an enable position) that blocks the pressure connection 256 from the tank 112. It is appreciated that the enable solenoid 264 can be a normally open solenoid, such that it only moves to the first position when commanded (e.g., energized) by the controller 120. Thus, controller 120 can effectively move the isolator spool 224 between the first and second isolator positions in accordance with a desired steering mode. For example, in some cases, the controller 120 can control the enable solenoid in accordance with an operator command, or based on another input (e.g., a sensor input). In some cases, the controller 120 may be configured to automatically switch from the electronic steering mode to the manual steering mode upon an operator providing a steering or other command at the manual input device 106.

In some cases, the isolator spool 224 may further include a second pressure connection 260 (e.g., a load sense or pilot pressure connection, or chamber) arranged on a same side as the biasing assembly 228 (i.e., opposite the first pressure connection 256). The second pressure connection 260 can be coupled to the pump 108 and tank 112 via the directional control spool, such that pressure at the second pressure connection 260 can work with the spring force provided by the second compliant member 236 to control movement between second and third isolator positions. More specifically, the second pressure connection 260 can be coupled between the relief valve 158 and the directional control spool 184. Correspondingly, the restriction orifice 288 can be positioned between the second pressure connection 260 and the directional control spool 184, so that the pressure at the second pilot pressure connection is at the same pressure at the pressure relief valve 158.

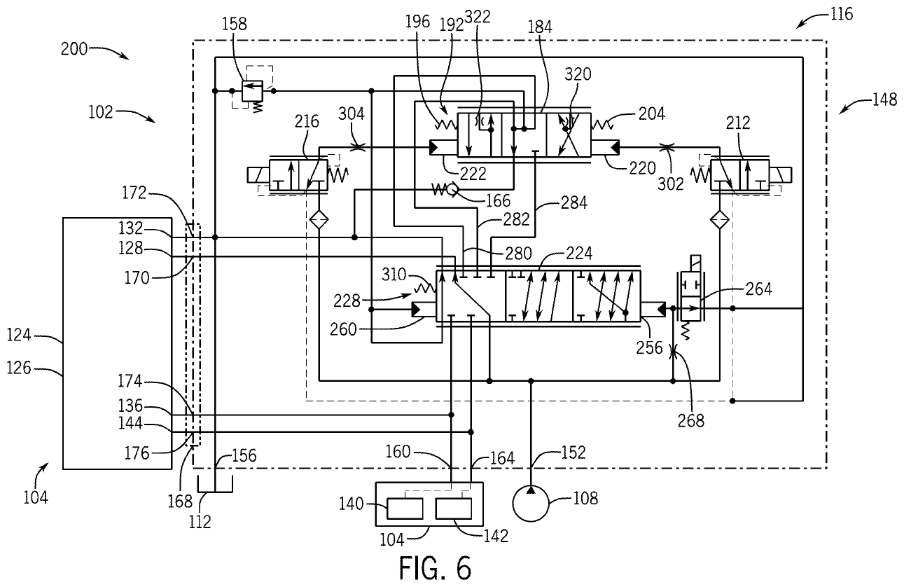

In other non-limiting examples, an electronic steering valve can be configured differently. FIGS. 6-9 depict aspects of another non-limiting example of steering system 200. It is appreciated that the steering system 200 is generally similar to the steering system 100, except as indicated below. For example, as best seen in FIG. 6, restriction orifices 302, 304 can provided between the directional control spool 184 and each of the first EPRV 212 and second EPRV 216 to limit flow between the pump port 152 and each of the first pilot pressure connection 220 and the second pilot pressure connection 222. The restriction orifices 302, 304 act as damping orifices that limit flow into or out of the pilot pressure connections 220 and 222, and dampen movement of the directional control spool 184. For example, when the directional control spool 184 moves toward the second directional position, the pressure at the first pilot pressure connection 220 will temporarily reduce to be less than that provided by the first EPRV 212, while the pressure at the second pilot pressure connection 222 will temporarily increase. Similarly, when the directional control spool 184 moves toward the third directional position, the pressure at the second pilot pressure connection 222 will temporarily reduce to be less than that provided by the second EPRV 216, while the pressure at the first pilot pressure connection 220 will temporarily increase. The restriction orifices 302, 304, can slow the rate of pressure change at the pilot pressure connections 220, 222, thereby dampening movement of the directional control spool 184.

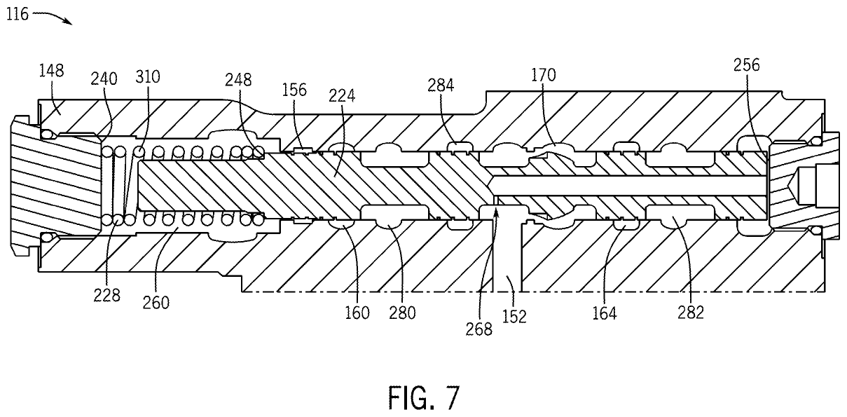

With additional reference to FIGS. 7-9, the biasing assembly 228 includes a single compliant member 310 (e.g., a spring or other resilient member), which extends and is retained between the first seat 240 and the third seat 248. Accordingly, the compliant member 310 can extend between the valve body 148 and the isolator spool 224. It is appreciated that the compliant member 310 can be set with an initial preload compression so as to bias the isolator spool 224 to the first isolator position. Additionally, the compliant member 310 can be compressed to allow movement of the isolator spool 224 between each of the three isolator positions. In this way, compliant member 310 can act to isolate the directional control spool 184 and to move to maintain margin pressure on the isolator spool 224 to control unloading of excess pump flow to the tank 112 in the electronic steering mode.

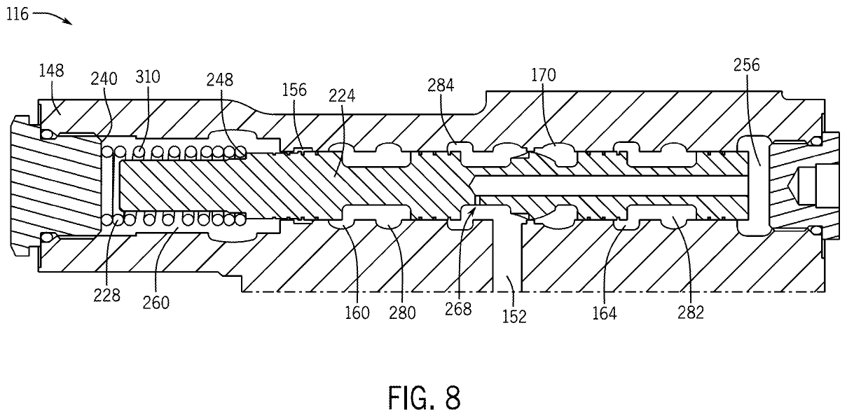

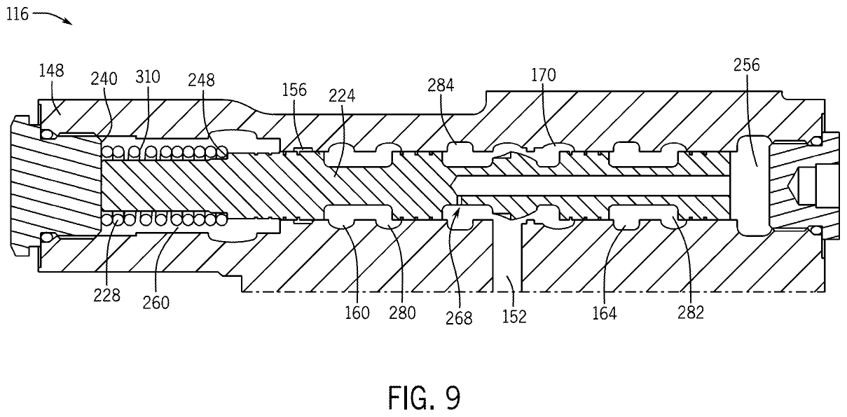

Correspondingly, the isolator spool 224 can be configured so that movement of the isolator spool 224 to and from the first isolator position (see e.g., FIG. 7) selectively couples the second pressure connection 260 to the tank 112. More specifically, in the first isolator position, the isolator spool 224 can couple the second pressure connection 260 to the tank 112, such that the second pressure connection 260 drains through the isolator spool 224. This reduces pressure on the second pressure connection 260 so that the compliant member 310 can bias the isolator spool to the first isolator position when the first pressure connection 256 is coupled to the tank 112 (e.g., via the enable solenoid 264). Correspondingly, when the first pressure connection 256 is blocked from the tank 112, the isolator spool 224 can move to the second or third isolator position (see e.g., FIGS. 8 and 9, respectively), which blocks the second pressure connection 260 from the tank 112 and allows pressure to build. Relatedly, the directional control spool 184 can include restriction orifices 320, 322 that can limit flow from the pump 108 to the second pressure connection 260. Further, in some cases, the second pressure connection 260 can be coupled between the tank port 156 and the spring biased check valve 166 to prevent flow form the second pressure connection 260 to the directional control spool 184.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

What is claimed is:

1. A control valve for a steering system for a hydraulic machine, the control valve comprising:
a valve body defining a first actuator port, a second actuator port, a tank port, a pump port, and a manual steer interface;
a directional control spool disposed within the valve body to selectively couple the first actuator port, the second actuator port, the tank port, and the pump port; and
an isolator spool disposed within the valve body to selectively couple the directional control spool to each of the first actuator port, the second actuator port, and the pump port, and to selectively couple the pump port to the manual steer interface.

2. The control valve of claim 1, wherein the directional control spool is configured to move between each of:
a first directional position that couples each of the first actuator port and the second actuator port to the tank port;
a second directional position that couples the pump port to the first actuator port and couples the second actuator port to the tank port; and
a third directional position that couples the pump port to the second actuator port and couples the first actuator port to the tank port.

3. The control valve of claim 2 further comprising a biasing assembly configured to bias the directional control spool into the first directional position.

4. The control valve of claim 3, wherein the biasing assembly includes a first directional control spring and a second directional control spring in an opposed configuration about the directional control spool to bias the directional control spool into the first directional position.

5. The control valve of claim 3 further comprising:
a first electronically controlled pressure regulating valve configured to move the directional control spool from the first directional position to the second directional position; and
a second electronically controlled pressure regulating valve configured to move the directional control spool from the first directional position to the third directional position.

6. The control valve of claim 5, wherein each of the first electronically controlled pressure regulating valve and the second electronically controlled pressure regulating valve is movable between a first position that couples a respective pilot pressure connection of the directional control spool to the tank port and a second position that couples the respective pilot pressure connection to the pump port.

7. The control valve of claim 1, wherein the isolator spool is configured to move between each of:
a first isolator position that blocks the first actuator port and the second actuator port from the directional control spool, and couples the pump port to the manual steer interface;
a second isolator position that blocks the manual steer interface from the pump port and couples the directional control spool to each of the first actuator port, the second actuator port, and the pump port; and
a third isolator position that that couples the pump port to the manual steer interface and couples the directional control spool to each of the first actuator port, the second actuator port, and the pump port.

8. The control valve of claim 7 further comprising a first isolator spring configured to bias the isolator spool to the first isolator position.

9. The control valve of claim 8, further comprising a second isolator spring arranged in series with the first isolator spring to bias the isolator spool to the first isolator position.

10. The control valve of claim 8, wherein a pressure connection of the isolator spool is coupled to the pump port, and further including an enable solenoid to selectively couple the pressure connection to the tank port to control movement of the isolator spool.

11. The control valve of claim 10, wherein the pressure connection is a first pressure connection and further including a second pressure connection arranged opposite isolator spool from the first pressure connection.

12. The control valve of claim 10, wherein the enable solenoid is configured as one of an on-off solenoid and proportional solenoid.

13. The control valve of claim 10, further comprising a restriction orifice positioned between the pump port and the pressure connection.

14. The control valve of claim 10, wherein the enable solenoid is operable between each of:
a disable position that couples the pressure connection to the tank port so that the isolator spool is biased to the first isolator position; and
an enable position that blocks the pressure connection from the tank port so that pressure at the pump port moves the isolator spool from the first isolator position toward the second isolator position.

15. The control valve of claim 14, wherein, with the enable solenoid in the enable position, position of the isolator spool is infinitely variable between the second isolator position and the third isolator position based on a pressure at the pressure connection.

16. The control valve of claim 1, wherein the manual steer interface is configured to couple with a manual steer valve and includes a pump connection, a tank connection, a first actuator connection, and a second actuator connection.

17. A steering system for a hydraulic machine having a pump, an actuator, and a tank, the steering system comprising:
a manual steering valve including a first pump connection, a first tank connection, a first actuator connection, and a second actuator connection, the manual steering valve configured to selectively couple the first pump connection, the first tank connection, the first actuator connection, and the second actuator connection; and
an electronic steering valve including:
a valve body defining a pump port configured to couple to the pump, a first actuator port configured to couple to the actuator, a second actuator port configured to couple to the actuator, a tank port configured to couple to the tank, a second pump connection configured to couple to the first pump connection, a second tank connection configured to couple to the first tank connection, a third actuator connection configured to couple to the first actuator connection, and a fourth actuator connection configured to couple to the second actuator connection;
a directional control spool disposed within the valve body, the directional control spool configured to selectively couple the pump port, the first actuator port, the second actuator port, and the tank port; and
an isolator spool disposed within the valve body, the isolator spool configured to switch the steering system between a manual steering mode, in which the directional control spool is decoupled from the pump port, the first actuator port, and the second actuator port by the isolator spool, an electronic steering mode, in which the directional control spool is coupled to the pump port, the first actuator port, and the second actuator port by the isolator spool.

18. The steering system of claim 17, wherein the third actuator connection is in direct communication with the first actuator port and the fourth actuator connection is in direct communication with the second actuator port.

19. The steering system of claim 17, wherein, in the manual steering mode, the isolator spool is in a first isolator position that blocks the first actuator port and the second actuator port from the directional control spool, and couples the pump port to the manual steering valve.

20. The steering system of claim 19, wherein, in the electronic steering mode, the isolator spool is movable between each of:
a second isolator position that blocks the manual steer valve from the pump port and couples the directional control spool to each of the first actuator port, the second actuator port, and the pump port; and
a third isolator position that that couples the pump port to the manual steer valve and couples the directional control spool to each of the first actuator port, the second actuator port, and the pump port.

21. The steering system of claim 17 further comprising an electronic controller configured to move the isolator spool to switch between the manual steering mode and the electronic steering mode.

22. The steering system of claim 21, wherein the electronic controller is configured to operate an enable solenoid that is configured to selectively couple a pressure connection of the isolator spool to the tank port to put the steering system in the manual steering mode and to decouple the pressure connection to the tank port to put the steering system in the electronic steering mode.

23. The steering system of claim 21, wherein, in the electronic steering mode, the electronic controller is configured operate a first electronically controlled pressure regulating valve and a second electronically controlled pressure regulating valve to move the directional control spool between each of:
a first directional position that couples each of the first actuator port and the second actuator port to the tank port;
a second directional position that couples the pump port to the first actuator port and couples the second actuator port to the tank port; and
a third directional position that couples the pump port to the second actuator port and couples the first actuator port to the tank port.

24. The steering system of claim 17, wherein the actuator includes a first actuator and a second actuator, the first actuator being coupled to the first actuator port and the second actuator being coupled to the second actuator port.
